(19) United States
(12) Patent Application Publication
(10) Pub. No.: US 2007/0247974 A1
(43) Pub. Date: Oct. 25, 2007

(54) Clock apparatus and method

(75) Inventors: Brent Duwe, Newnan, GA (US); Kenneth Earl Ramsey, Fayetteville, GA (US); George Michael Drake, Newnan, GA (US)

Correspondence Address: KING & SPALDING LLP, 1180 PEACHTREE STREET, ATLANTA, GA, 30309-3521, US

(73) Assignee: Cooper Technologies Company, Houston, TX (US)

(21) Appl. No.: 11/407,256

(22) Filed: Apr. 19, 2006

(51) Int. Cl. G04F 8/00

(52) U.S. Cl. 368/1

(57) ABSTRACT

An apparatus and method according to which a clock is adapted to be illuminated by, for example, one or more light-emitting-diode bulbs.

### CROSS-REFERENCE TO RELATED APPLICATIONS

The present application is related to the following co-pending applications: U.S. design patent application no. 29/246483, attorney docket number 23667.371, filed on Apr. 18, 2006; U.S. design patent application no. 29/246485, attorney docket no. 23667.372, filed on Apr. 18, 2006; U.S. design patent application no. 29/246486, attorney docket no. 23667.373, filed on Apr. 18, 2006; and U.S. application Ser. No. ______, attorney docket no. 23667.219, filed on Apr. 19, 2006, the disclosures of which are incorporated herein by reference.

### BACKGROUND

The present disclosure relates in general to clocks and in particular to a clock adapted to be illuminated by, for example, one or more light-emitting-diode bulbs.

### BRIEF DESCRIPTION OF THE DRAWINGS

FIG. 1 is a perspective view of a time-keeping assembly according to an embodiment, the assembly including a clock face.

FIG. 2 is a front elevational view of the assembly of FIG. 1 with portions of the clock face removed for clarity purposes.

FIG. 3 is a partial diagrammatic/partial front elevational view of the assembly of FIGS. 1 and 2 depicting the operable couplings between components of the assembly of FIGS. 1 and 2.

FIG. 4 is a perspective view of a time-keeping assembly according to another embodiment, the assembly including a clock face.

FIG. 5 is a front elevational view of the assembly of FIG. 4.

FIG. 6 is a partial diagrammatic/partial front elevational view of the assembly of FIGS. 4 and 5 depicting the operable couplings between components of the assembly of FIGS. 4 and 5.

### DETAILED DESCRIPTION

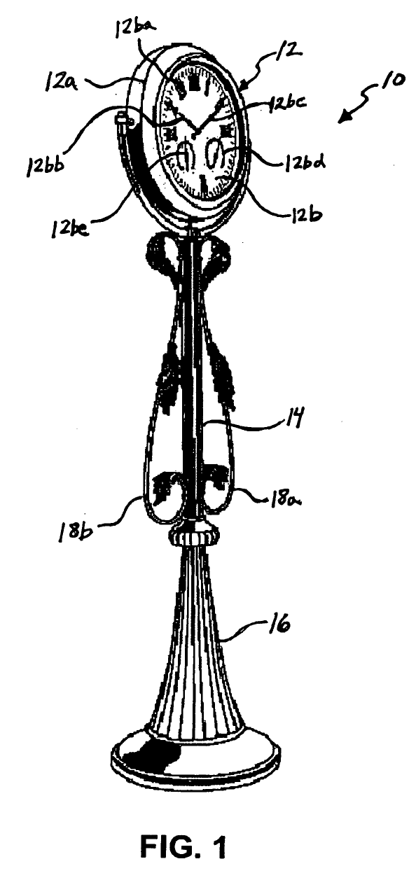

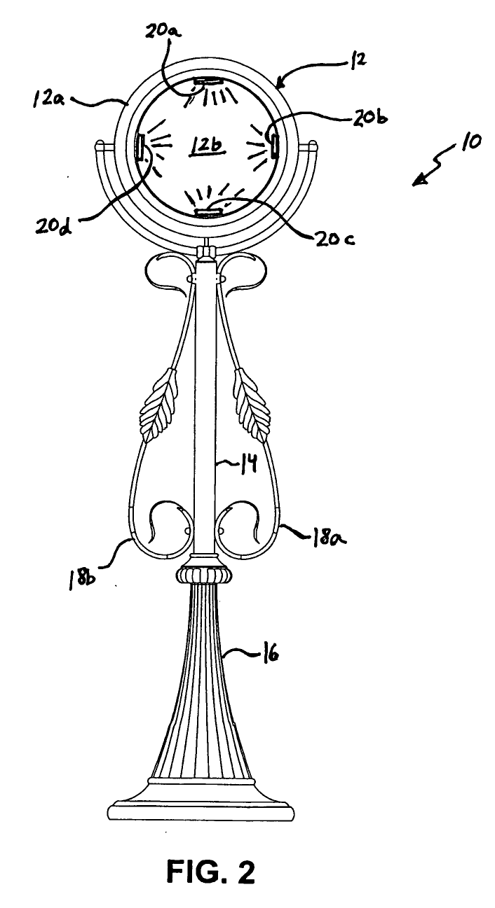

In an exemplary embodiment, as illustrated in FIGS. 1 and 2, a time-keeping assembly is generally referred to by the reference numeral 10 and includes a clock 12 and a center pole 14 coupled thereto. A base 16, and decorative-leaf side bars 18a and 18b, are coupled to the center pole 14. In an exemplary embodiment, the base 16 is weighted. In an exemplary embodiment, the side bars 18a and 18b are fastened to the center pole 14 using screws, thereby coupling the side bars 18a and 18b to the center pole 14. In an exemplary embodiment, an end of the center pole 14 comprises an internal threaded connection that threadably engages an upwardly-extending external threaded connection of the base 16, thereby coupling the base 16 to the center pole 14, and the other end of the center pole 14 is secured to the clock 12 using a screw, thereby coupling the center pole 14 to the clock 12.

The clock 12 includes an annular frame 12a across which a clock face 12b extends. The clock face 12b includes clock numbers 12ba, an hour hand 12bb, a minute hand 12bc, a built-in dial thermometer 12bd and a built-in dial barometer 12be. In an exemplary embodiment, the clock face 12b comprises a diameter of about 18 inches. In an exemplary embodiment, each of the clock numbers 12ba comprises a material that is adapted to glow in response to light shining on the clock numbers 12ba, as will be described in further detail below. In an exemplary embodiment, the clock 12 is powered by a battery. In an exemplary embodiment, the clock 12 is powered by a single AA cell battery.

In several exemplary embodiments, the annular frame 12a of the clock 12, the center pole 14, the base 16 and the side bars 18a and 18b comprise heavy-duty metal construction. In an exemplary embodiment, the assembly 10 is weather resistant using conventional weather-resistant design aspects and/or features such as, for example, conventional weather-resistant finishes.

Circumferentially-spaced light-emitting-diode (LED) bulbs 20a, 20b, 20c and 20d are coupled to the clock 12 and are adapted to illuminate one or more portions of the clock face 12b under conditions to be described. The LED bulbs 20a, 20b, 20c and 20d are positioned along and adjacent, or nearly adjacent, the perimeter of the clock face 12b, with the LED bulb 20a being positioned at about the 12 o'clock position on the clock face 12b, the LED bulb 20b being positioned at about the 3 o'clock position on the clock face 12b, the LED bulb 20c being positioned at about the 6 o'clock position on the clock face 12b, and the LED bulb 20d being positioned at about the 9 o'clock position on the clock face 12b.

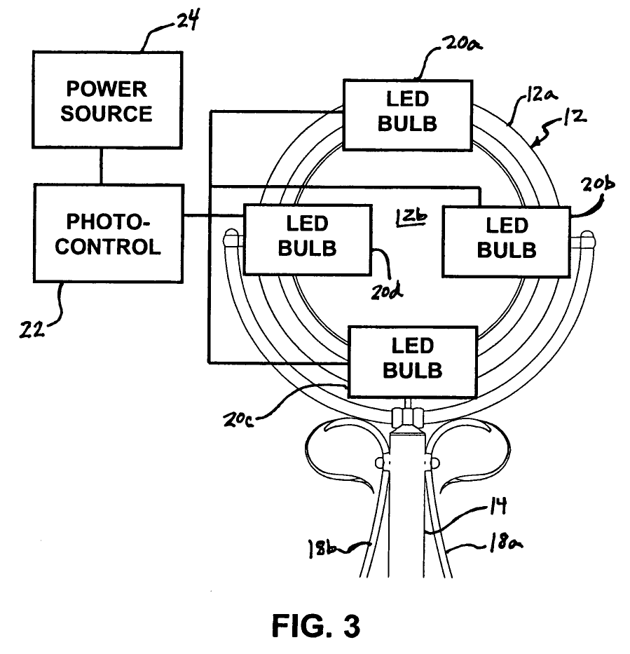

In an exemplary embodiment, as illustrated in FIGS. 1, 2 and 3, the LED bulbs 20a, 20b, 20c and 20d are operably coupled to a photocontrol 22, which is adapted to control the operation of the LED bulbs 20a, 20b, 20c and 20d under conditions to be described. In an exemplary embodiment, the photocontrol 22 comprises a photocell. A source of power 24 is operably coupled to the photocontrol 22 and is adapted to supply power to the LED bulbs 20a, 20b, 20c and 20d in an amount sufficient to cause the LED bulbs 20a, 20b, 20c and 20d to illuminate one or more portions of the clock face 12b, under conditions to be described. In an exemplary embodiment, the source of power 24 comprises one or more batteries. In an exemplary embodiment, the source of power 24 comprises four (4) D cell batteries. In several exemplary embodiments, the photocontrol 22 and/or the source of power 24 are mounted on and/or within the clock 12. In an exemplary embodiment, an on/off switch is operably coupled to the source of power 24.

During installation, the assembly 10 is positioned in any indoor or outdoor location such as, for example, a patio, a porch, a sunroom, a deck and/or a garden. The above-described weather resistance of the assembly 10 permits the assembly 10 to be positioned in any outdoor location. The weighted base 14 facilitates the support of the assembly 10 and the maintenance of an upright position of the assembly 10 during and after installation. In several exemplary embodiments, and if necessary, the thermometer 12bd and/or the barometer 12be are calibrated after positioning the assembly 10. In an exemplary embodiment, if the on/off switch is operably coupled to the source of power 24, the on/off switch is placed in the on position after positioning the assembly 10 to permit the LED bulbs 20a, 20b, 20c and 20d to be powered under conditions to be described.

In operation, the clock 12 of the assembly 10 operates to indicate the time, the thermometer 12bd operates to measure and indicate the temperature of the air surrounding the assembly 10, and the barometer 12be operates to measure and indicate the barometric pressure of the atmosphere surrounding the assembly 10.

If the assembly 10 is installed in an outdoor location, or in any location that is sufficiently exposed to daylight during the day, and during daytime operation, the photocontrol 22 operates to generally prevent the LED bulbs 20a, 20b, 20c and 20d from illuminating one or more portions of the clock face 12b. The photocontrol 22 so operates in response to the presence of daylight during daytime operation.

At nightfall, the photocontrol 22 operates to automatically turn the LED bulbs 20a, 20b, 20c and 20d on. That is, as a result of nightfall and the absence of daylight, the photocontrol 22 operates to permit the source of electrical power 24 to supply power to the LED bulbs 20a, 20b, 20c and 20d in an amount sufficient to cause the LED bulbs 20a, 20b, 20c and 20d to illuminate one or more portions of the clock face 12b, thereby permitting the clock face 12b to be read and the time, temperature and/or barometric pressure to be visually ascertained during the night. The LED bulbs 20a, 20b, 20c and 20d continue to so illuminate the clock face 12b throughout the night. The material of the clock numbers 12ba enhances the illumination of the clock numbers 12ba in response to the shining light provided by the LED bulbs 20a, 20b, 20c and 20d, thereby causing the clock numbers 12ba to glow.

At dawn, the photocontrol 22 operates to automatically turn the LED bulbs 20a, 20b, 20c and 20d off. The above-described daytime operation of the assembly 10 is then repeated throughout the day. At nightfall, the above-described nighttime operation of the assembly 10 is then repeated.

The above-described operation of the assembly 10 continues as long as the source of power 24 is able, during nighttime operation and in response to the operation of the photocontrol 22, to continue to supply electrical power in an amount sufficient to cause the LED bulbs 20a, 20b, 20c and 20d to illuminate one or more portions of the clock face 12b.

In an exemplary embodiment, the photocontrol 22 may be operably coupled to the LED bulbs 20a, 20b, 20c and 20d so that, if one or more of the LED bulbs fail, the other LED bulbs continue to operate in the manner described above. In an exemplary embodiment, the photocontrol may be operably coupled to the LED bulbs 20a, 20b, 20c and 20d so that, if one or more of the LED bulbs fail, all of the LED bulbs cease to operate in the manner described above.

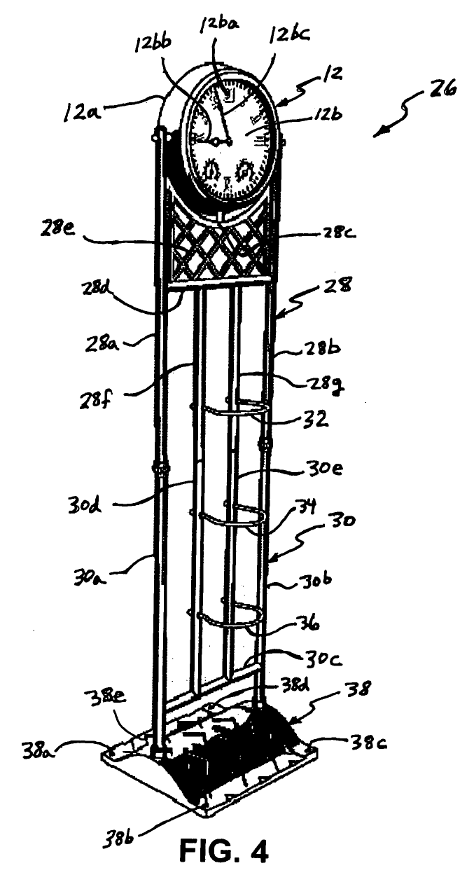

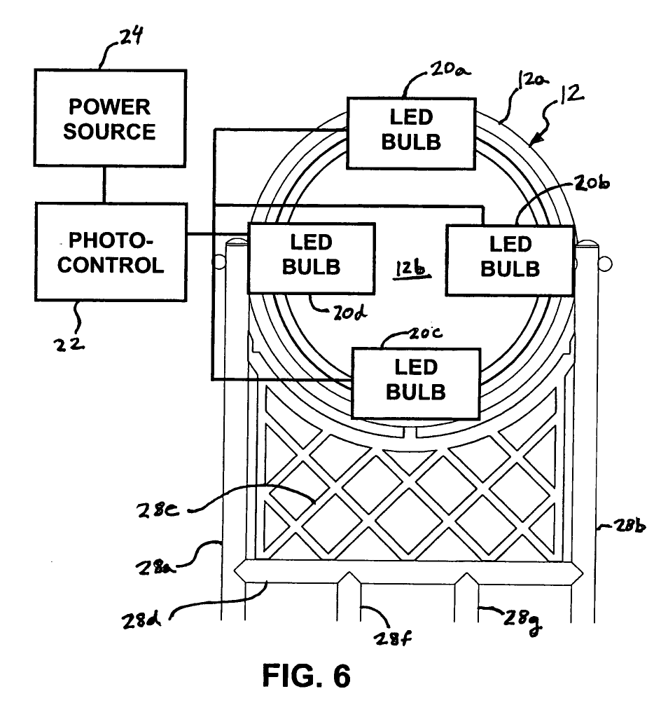

In an exemplary embodiment, as illustrated in FIGS. 4, 5 and 6, a time-keeping assembly is generally referred to by the reference numeral 26 and includes several components of the assembly 10 of FIGS. 1-3, which are given the same reference numerals. These components include the clock 12, the LED bulbs 20a, 20b, 20c and 20d, the photocontrol 22 and the source of power 24.

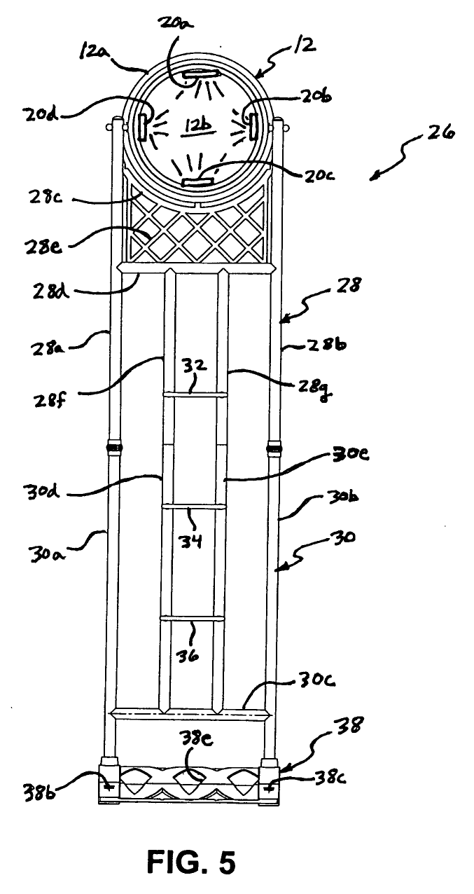

In the embodiment of FIGS. 4 and 5, the assembly 26 includes an upper stand 28 that is coupled to a lower stand 30. The upper stand 28 includes a pair of vertically-extending members 28a and 28b, which are coupled to the frame 12a of the clock 12 and extend downward therefrom. A curved bar 28c and a horizontally-extending bar 28d extend between the members 28a and 28b. A lattice structure 28e extends between the members 28a and 28b, the curved bar 28c, and the horizontally-extending bar 28d. A pair of vertically-extending members 28f and 28g extend downward from the horizontally-extending bar 28d.

The lower stand 30 includes a pair of vertically-extending members 30a and 30b that are coupled to the members 28a and 28b, respectively, of the upper stand 28. A horizontally-extending bar 30c extends between the members 30a and 30b. A pair of vertically-extending members 30d and 30e extend upwardly from the bar 30c and are coupled to the members 28f and 28g, respectively, of the upper stand 28.

A plant holder 32 is coupled to the members 28f and 28g of the upper stand 28. Plant holders 34 and 36 are each coupled to the members 30d and 30e of the lower stand 30. A base 38 is coupled to the members 30a and 30b of the lower stand, and includes through-holes 38a, 38b, 38c and 38d, and a lattice structure 38e.

The installation of the assembly 26 is substantially similar to the above-described installation of the assembly 10 of FIGS. 1-3, and therefore the installation of the assembly 26 will not be described in detail. In an exemplary embodiment, if the assembly 26 is positioned outdoors and on the ground, stakes may extend through the through-holes 38a, 38b, 38c and 38d, respectively, of the base 38, and may be driven into the ground to provide additional support to the assembly 26 during and after installation.

In an exemplary embodiment, each of the plant holders 32, 34 and 36 may hold a pot for plants and/or flowers, thereby visually enhancing the environment in which the assembly 26 is installed such as, for example, a patio and/or garden. In an exemplary embodiment, the upper stand 28 and the lower stand 30, and the above-described components thereof, may serve as a trellis for any vine plants.

The operation of the assembly 26 is substantially similar to the above-described operation of the assembly 10 of FIGS. 1-3, and therefore the operation of the assembly 26 will not be described in detail.

An apparatus has been described that includes a clock comprising a clock face; and at least one LED bulb coupled to the clock; wherein the at least one LED bulb is positioned so that the at least one LED bulb is adapted to illuminate at least a portion of the clock face. In an exemplary embodiment, the apparatus comprises a photocontrol operably coupled to the at least one LED bulb. In an exemplary embodiment, the photocontrol comprises a first configuration in which the photocontrol generally prevents the at least one LED bulb from illuminating the at least a portion of the clock face; and a second configuration in which the photocontrol generally permits the at least one LED bulb to illuminate the at least a portion of the clock face. In an exemplary embodiment, the photocontrol is placed in the first configuration in response to the presence of daylight; and wherein the photocontrol is placed in the second configuration in response to the absence of daylight. In an exemplary embodiment, the at least one LED bulb is positioned along the perimeter of the clock face; and wherein the apparatus further comprises at least one other LED bulb coupled to the clock and adapted to illuminate at least another portion of the clock face, the at least one other LED bulb being positioned along the perimeter of the clock face and circumferentially spaced from the at least one LED bulb. In an exemplary embodiment, the apparatus comprises a photocontrol operably coupled to the at least one LED bulb and to the at least one other LED bulb. In an exemplary embodiment, the clock further comprises at least one device selected from the group consisting of a thermometer, a barometer and a hygrometer. In an exemplary embodiment, the apparatus comprises at least one stand coupled to the clock; and at least one pot holder coupled to the stand.

An apparatus has been described that includes a clock comprising a clock face; at least one LED bulb coupled to the clock and adapted to illuminate at least a portion of the clock face, the at least one LED bulb being positioned along the perimeter of the clock face; at least one other LED bulb coupled to the clock and adapted to illuminate at least another portion of the clock face, the at least one other LED bulb being positioned along the perimeter of the clock face and circumferentially spaced from the at least one LED bulb; a photocontrol operably coupled to the at least one LED bulb and to the at least one other LED bulb, the photocontrol comprising a first configuration in which the photocontrol generally prevents the at least one LED bulb from illuminating the at least a portion of the clock face, and the photocontrol generally prevents the at least one other LED bulb from illuminating the at least another portion of the clock face, wherein the photocontrol is placed in the first configuration in response to the presence of daylight; and a second configuration in which the photocontrol generally permits the at least one LED bulb to illuminate the at least a portion of the clock face, and the photocontrol generally permits the at least one other LED bulb to illuminate the at least another portion of the clock face, wherein the photocontrol is placed in the second configuration in response to the absence of daylight.

A method has been described that includes providing a clock comprising a clock face; and controlling the illumination of at least a portion of the clock face, comprising controlling the operation of at least one LED bulb coupled to the clock. In an exemplary embodiment, controlling the operation of the at least one LED bulb coupled to the clock comprises turning the at least one LED bulb off in response to the presence of daylight; and turning the at least one LED bulb on in response to the absence of daylight. In an exemplary embodiment, the method comprises at least one of measuring the temperature of the air surrounding the clock; measuring the barometric pressure of the atmosphere surrounding the clock; and measuring the relative humidity of the air surrounding the clock. In an exemplary embodiment, the method comprises coupling a trellis to the clock. In an exemplary embodiment, the method comprises coupling a pot holder to the clock.

A method has been described that includes providing a clock comprising a clock face; and controlling the illumination of at least a portion of the clock face, comprising controlling the operation of at least one LED bulb coupled to the clock, comprising turning the at least one LED bulb off in response to the presence of daylight; and turning the at least one LED bulb on in response to the absence of daylight; wherein the method further comprises at least one of measuring the temperature of the air surrounding the clock; measuring the barometric pressure of the atmosphere surrounding the clock; and measuring the relative humidity of the air surrounding the clock.

A system has been described that includes means for providing a clock comprising a clock face; and means for controlling the illumination of at least a portion of the clock face, comprising means for controlling the operation of at least one LED bulb coupled to the clock. In an exemplary embodiment, means for controlling the operation of the at least one LED bulb coupled to the clock comprises means for turning the at least one LED bulb off in response to the presence of daylight; and means for turning the at least one LED bulb on in response to the absence of daylight. In an exemplary embodiment, the system comprises at least one of means for measuring the temperature of the air surrounding the clock; means for measuring the barometric pressure of the atmosphere surrounding the clock; and means for measuring the relative humidity of the air surrounding the clock. In an exemplary embodiment, the system comprises means for coupling a trellis to the clock. In an exemplary embodiment, the system comprises means for coupling a pot holder to the clock.

A system has been described that includes means for providing a clock comprising a clock face; and means for controlling the illumination of at least a portion of the clock face, comprising means for controlling the operation of at least one LED bulb coupled to the clock, comprising means for turning the at least one LED bulb off in response to the presence of daylight; and means for turning the at least one LED bulb on in response to the absence of daylight; wherein the system further comprises at least one of means for measuring the temperature of the air surrounding the clock; means for measuring the barometric pressure of the atmosphere surrounding the clock; and means for measuring the relative humidity of the air surrounding the clock.

It is understood that variations may be made in the foregoing without departing from the scope of the disclosure. For example, instead of, or in addition to, the thermometer 12bd and/or the barometer 12be, the clock face 12b may include a built-in dial hygrometer for measuring and indicating the relative humidity of the air surrounding the assembly 10. If the clock face 12b includes a hygrometer, the hygrometer may be calibrated after positioning the assembly 10, if necessary. Also, the thermometer 12bd and/or the barometer 12be may be removed from the clock 12. Further, at any point in time, and if the on/off switch is operably coupled to the source of power 24 and the source of power 24 comprises one or more batteries, the on/off switch may be placed in an off position to prolong the life of the one or more batteries of the source of power 24.

Any spatial references such as, for example, “upper,” “lower,” “above,” “below,” “between,” “vertical,” “angular,” “upward,” “downward,” “side-to-side,” “left-to-right,” “right-to-left,” “top-to-bottom,” “bottom-to-top,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. An apparatus comprising:
a clock comprising a clock face; and
at least one LED bulb coupled to the clock;
wherein the at least one LED bulb is positioned so that the at least one LED bulb is adapted to illuminate at least a portion of the clock face.

2. The apparatus of claim 1 further comprising:
a photocontrol operably coupled to the at least one LED bulb.

3. The apparatus of claim 2 wherein the photocontrol comprises:
a first configuration in which the photocontrol generally prevents the at least one LED bulb from illuminating the at least a portion of the clock face; and
a second configuration in which the photocontrol generally permits the at least one LED bulb to illuminate the at least a portion of the clock face.

4. The apparatus of claim 3 wherein the photocontrol is placed in the first configuration in response to the presence of daylight; and
wherein the photocontrol is placed in the second configuration in response to the absence of daylight.

5. The apparatus of claim 1 wherein the at least one LED bulb is positioned along the perimeter of the clock face; and
wherein the apparatus further comprises at least one other LED bulb coupled to the clock and adapted to illuminate at least another portion of the clock face, the at least one other LED bulb being positioned along the perimeter of the clock face and circumferentially spaced from the at least one LED bulb.

6. The apparatus of claim 5 further comprising:
a photocontrol operably coupled to the at least one LED bulb and to the at least one other LED bulb.

7. The apparatus of claim 1 wherein the clock further comprises at least one device selected from the group consisting of a thermometer, a barometer and a hygrometer.

8. The apparatus of claim 1 further comprising:
at least one stand coupled to the clock; and
at least one pot holder coupled to the stand.

9. An apparatus comprising:
a clock comprising a clock face;
at least one LED bulb coupled to the clock and adapted to illuminate at least a portion of the clock face, the at least one LED bulb being positioned along the perimeter of the clock face;
at least one other LED bulb coupled to the clock and adapted to illuminate at least another portion of the clock face, the at least one other LED bulb being positioned along the perimeter of the clock face and circumferentially spaced from the at least one LED bulb;
a photocontrol operably coupled to the at least one LED bulb and to the at least one other LED bulb, the photocontrol comprising:
a first configuration in which:
the photocontrol generally prevents the at least one LED bulb from illuminating the at least a portion of the clock face, and
the photocontrol generally prevents the at least one other LED bulb from illuminating the at least another portion of the clock face,
wherein the photocontrol is placed in the first configuration in response to the presence of daylight; and
a second configuration in which:
the photocontrol generally permits the at least one LED bulb to illuminate the at least a portion of the clock face, and
the photocontrol generally permits the at least one other LED bulb to illuminate the at least another portion of the clock face,
wherein the photocontrol is placed in the second configuration in response to the absence of daylight.

10. A method comprising:
providing a clock comprising a clock face; and
controlling the illumination of at least a portion of the clock face, comprising:
controlling the operation of at least one LED bulb coupled to the clock.

11. The method of claim 10 wherein controlling the operation of the at least one LED bulb coupled to the clock comprises:
turning the at least one LED bulb off in response to the presence of daylight; and
turning the at least one LED bulb on in response to the absence of daylight.

12. The method of claim 10 further comprising at least one of:
measuring the temperature of the air surrounding the clock;
measuring the barometric pressure of the atmosphere surrounding the clock; and
measuring the relative humidity of the air surrounding the clock.

13. The method of claim 10 further comprising:
coupling a trellis to the clock.

14. The method of claim 10 further comprising:
coupling a pot holder to the clock.

15. A method comprising:
providing a clock comprising a clock face; and
controlling the illumination of at least a portion of the clock face, comprising:
controlling the operation of at least one LED bulb coupled to the clock, comprising:
turning the at least one LED bulb off in response to the presence of daylight; and
turning the at least one LED bulb on in response to the absence of daylight;
wherein the method further comprises at least one of:
measuring the temperature of the air surrounding the clock;
measuring the barometric pressure of the atmosphere surrounding the clock; and
measuring the relative humidity of the air surrounding the clock.

16. A system comprising:
means for providing a clock comprising a clock face; and
means for controlling the illumination of at least a portion of the clock face, comprising:
means for controlling the operation of at least one LED bulb coupled to the clock.

17. The system of claim 16 wherein means for controlling the operation of the at least one LED bulb coupled to the clock comprises:
means for turning the at least one LED bulb off in response to the presence of daylight; and
means for turning the at least one LED bulb on in response to the absence of daylight.

18. The system of claim 16 further comprising at least one of:
means for measuring the temperature of the air surrounding the clock;
means for measuring the barometric pressure of the atmosphere surrounding the clock; and
means for measuring the relative humidity of the air surrounding the clock.

19. The system of claim 16 further comprising:
means for coupling a trellis to the clock.

20. The system of claim 16 further comprising:
means for coupling a pot holder to the clock.

21. A system comprising:
means for providing a clock comprising a clock face; and
means for controlling the illumination of at least a portion of the clock face, comprising:
means for controlling the operation of at least one LED bulb coupled to the clock, comprising:
means for turning the at least one LED bulb off in response to the presence of daylight; and
means for turning the at least one LED bulb on in response to the absence of daylight;
wherein the system further comprises at least one of:
means for measuring the temperature of the air surrounding the clock;
means for measuring the barometric pressure of the atmosphere surrounding the clock; and
means for measuring the relative humidity of the air surrounding the clock.
